(19) United States
(12) Patent Application Publication
(10) Pub. No.: US 2020/0125506 A1
(43) Pub. Date: Apr. 23, 2020

(54) Superscalar Memory IC, Bus And System For Use Therein

(71) Applicants: Etron Technology, Inc., Hsinchu (TW); ETRON TECHNOLOGY AMERICA, INC., Santa Clara, CA (US)

(72) Inventor: Richard Dewitt Crisp, Hornitos, CA (US)

(21) Appl. No.: 16/656,168

(22) Filed: Oct. 17, 2019

Related U.S. Application Data
(60) Provisional application No. 62/749,403, filed on Oct. 23, 2018.

(51) Int. Cl. G06F 13/16

(52) U.S. Cl. CPC G06F 13/1668

(57) ABSTRACT

A multi-bank Superscalar Memory IC and system for use therein is disclosed. Using multiple independent addressing ports, multiple memory locations can be accessed simultaneously leading to a higher level of concurrency than supported by common DDR type memories. One disclosed embodiment is a Memory IC with two separate Data IO Ports that can support simultaneous read and write operations to the same memory IC, leading to reduced operating power for a given realtime video processing workload by exploiting the higher level of concurrency to deserialize operations leading to a reduction in operating clock frequency.

### CROSS-REFERENCE TO RELATED APPLICATIONS

This application claims the benefit of the filing date of U.S. Provisional Patent Application No. 62/749,403 filed Oct. 23, 2018, the disclosure of which is hereby incorporated herein by reference.

### BACKGROUND OF THE INVENTION

Memory systems are frequently constructed using Dynamic RAM ICs. Dynamic RAM ICs commonly are architected such that the dynamic RAM memory storage cells are arranged in a two-dimensional storage array accessible via row and column addresses. In this scheme row addresses specify a word line that destructively couples charge from selected storage cells onto bitlines establishing a small voltage by charge sharing. This small voltage is then sensed (amplified) and is written back (restored) into the corresponding originating bit cells. Column addresses are used to select which bitlines are to be accessed and the data is either read out to complete a read operation or is overwritten with new data if the memory is performing a write operation.

Accessing the memory normally consists decoding a column address to access a group of bitlines that have previously been sensed (open page). If the desired memory data has not yet been sensed (page miss), then the currently sensed data must be restored into the original source memory bits, the bitlines precharged (page precharge), a new row address decoded and the corresponding memory bits coupled to the bitlines and sensed (row activation) as previously explained. Only after the proper bits are selected and sensed on the bitlines can the column address select the desired data to complete the memory access operation.

Because the memory matrix is arranged into a two-dimensional array, one row address normally results in many bits being sensed concurrently. When a row address is changed, also called a row operation, the bitlines must be precharged and then a new wordline is selected followed by the bitlines being sensed, resulting in new data being available to be read or to be overwritten. Changing a row address as described results in power being dissipated as charge is moved around the IC.

In order to read out data or to overwrite existing data, a column must be accessed (also called a column operation). The operation consists of decoding column addresses to select the desired bitlines and then gating the data from the bitlines onto amplifiers to permit the data to be read out or to be overwritten depending on whether the column operation is a read or write operation.

In general, both the time needed and power dissipated performing row operations is different than for column operations. From a performance perspective, it is desirable to only access open pages.

The memory storage array of most Dynamic RAM ICs is divided into separately addressable banks to better manage power and efficiency. Since each bank can have an open page, this bank organization scheme increases the chances of accessing data in an open page.

Because each bank is independently addressable, it is possible to perform row and column operations simultaneously within different banks of the memory array.

One measure of Memory IC's Efficiency is the percentage of time that its data bus is transferring useful data versus the total time needed to execute a given benchmark memory load. Factors influencing efficiency include memory access patterns, how read and write operations are intermixed, how many of the accesses are to open pages (page hits), average data transfer length as well as the number and size of banks in the memory system.

If an access results in a DRAM page miss, then both a row activation operation and a column operation must be executed on the desired page before its data can be accessed, which reduces efficiency. On the other hand, if an access is to an open page, then only a column operation is needed leading to reduced latency and higher efficiency. DRAM efficiency, therefore is improved if pages can be opened in advance of requiring a data transfer to it.

A Two Way Superscalar Processor is a processor that can issue up to two instructions per cycle each instruction using its own data operands and executing on separate hardware resources. Either instruction could execute on either hardware resources: they are generally symmetric. As a result it is said there are two “Ways” the processor can execute the same pair of instructions, each comprising a “Way”. As another example of usage of the term “Way” is a Two Way Set Associative Cache, which has two generally identical storage regions in which any cached datum may possibly be stored (two “Ways” to store the datum).

A trend in systems designs is to incorporate multi-core processors or multi-issue processors such as superscalar processors. In these systems the processor can execute multiple instructions simultaneously, each being part of a different task or thread, and organized in a manner that exploits the inherent parallelism of many signal processing applications by performing multiple tasks in parallel. One example is a system used to capture realtime video and which performs transformations on the video data in realtime order to format the video for display. In this arrangement one processor core may handle the video capture and writing to memory while another processor core may access the stored data and perform operations on the data to format it for display.

While Dual Port SRAMs have been in existence for many years, the bit capacities are comparatively low compared to needs for High Definition and higher resolution video buffering. Moreover, the cost is prohibitively high for the Memory ICs, due to the large area required for a dual ported SRAM bit cell circuit on the memory IC as well as the large pincount package needed for the IC arising from the architectural requirements that demand a high interface signal count.

### BRIEF SUMMARY OF THE INVENTION

One embodiment of the invention introduces a functional generalization of the operation of the banks, that taken in combination, comprise a DRAM IC's memory array. The invention includes a superscalar operation mode wherein two operations may be executed per cycle. The architecture permits commands involving row operations (precharge, activate, refresh) to be issued to the same Memory IC during the same cycle as commands involving column operations (burst read, burst write, burst stop, r/w toggle etc). In the invention, any two banks can be accessed simultaneously: each one using command and addressing information directed to it alone.

In another embodiment of the invention one bank can execute a row operation controlled by externally supplied command and addressing information directed to the row operation alone while a second but different bank can simultaneously execute a column operation controlled by an externally supplied command and addresses directed to it alone.

In yet another embodiment of the invention one bank can perform a row operation directed by a row command received via a first single signal wire with addressing information simultaneously received via a second single signal wire. In this embodiment a second bank can concurrently perform a column operation directed by a column command received via the same first single signal wire as the row command and within the same memory cycle with column addressing information simultaneously received via by a third single signal wire. In this embodiment, the command port, the row address port and the column address port are adapted to each connect to a separate single signal wire to form a three-wire command/address interface when used in a system. A single Data IO Port is used in this configuration.

In still another embodiment of the invention two separate memory banks in a memory IC can be simultaneously and independently accessed using two independent address ports forming a two-way superscalar memory. Instead of only a single Data IO port, a variant employs two Data IO Ports, each capable of independent directional control. Other embodiments of the invention may increase the number of concurrently-operating banks, data ports and addressing therefor. For example, a four-way superscalar memory would access up to four banks simultaneously with each independently and simultaneously controllable and addressable and practice the spirit of an aspect of the invention.

### BRIEF DESCRIPTION OF THE DRAWINGS

FIG. 1 is a block diagram of an example device according to aspects of the disclosure.

FIG. 2 illustrates example bit assignments according to aspects of the disclosure.

FIG. 3 illustrates an example a timing diagram according to aspects of the disclosure.

FIG. 4 illustrates an example truth table according to aspects of the disclosure.

FIG. 5 illustrates an example format of a Column Serial Address according to aspects of the disclosure.

FIG. 6 illustrates an example format of a Row Serial Address according to aspects of the disclosure.

FIG. 7 illustrates an example bus operation according to aspects of the disclosure.

FIG. 8 is a more detailed view of the bus operation of FIG. 7.

FIG. 9 illustrates example parameters for populating Mode Registers according to aspects of the disclosure.

FIG. 10 illustrates two Mode Register field definitions according to aspects of the disclosure.

FIG. 11 illustrates an example memory array, and refresh control thereof, according to aspects of the disclosure.

FIG. 12 illustrates an example reset according to aspects of the disclosure.

FIG. 13 illustrates a block diagram and bus timing diagram for a two-way superscalar memory in accordance with an aspect of the disclosure.

FIG. 14 illustrates a Data IO block and associated timing diagram showing how two data streams are combined for off chip transport using a 1:1 clock frequency/data gear ratio in accordance with this disclosure.

FIG. 15 illustrates a configuration option for the data block of FIG. 14.

FIG. 16 illustrates Data IO block and associated timing diagram showing how two data streams are combined for off chip transport using a 8:1 clock frequency/data gear ratio in accordance with this disclosure.

FIG. 17 illustrates a configuration option for the data block of FIG. 16.

FIG. 18 illustrates a multi-core processor—superscalar memory subsystem in accordance with this disclosure.

FIG. 19 illustrates an appliance incorporating a multi-core processor and superscalar memory subsystem that combines one or more sensors of natural data types and the data stream therefrom with processing and display functions therefor.

### DETAILED DESCRIPTION

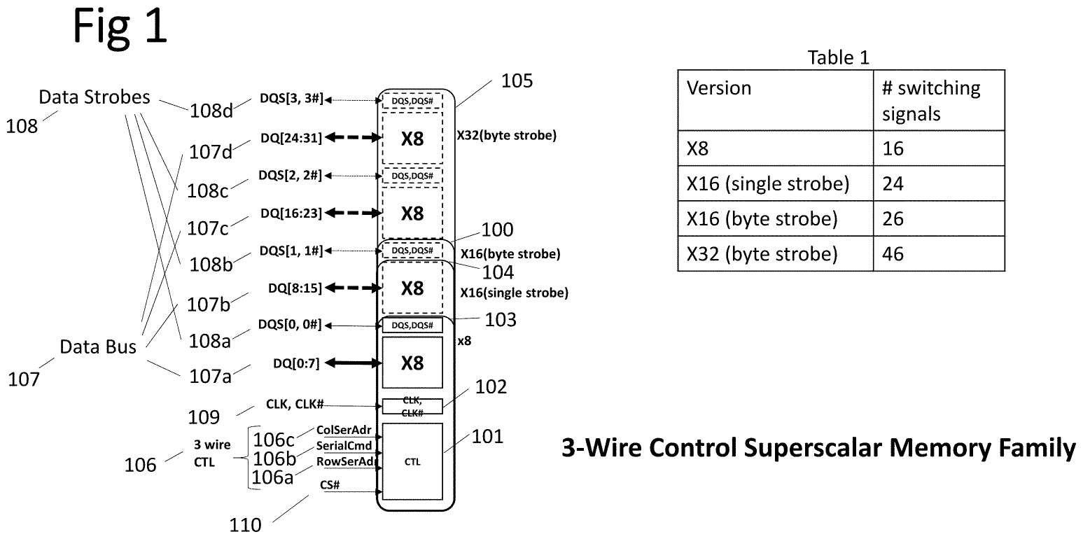

FIG. 1 illustrates one implementation of a superscalar Memory IC, including a DRAM architecture including a controller 101 and clock 102. The Memory IC uses a three-wire control 106 comprising a Serial Command 106b, a Serial Row Address 106a and a Serial Column Address 106c. Each main cycle consists of eight cycles of a bus clock 109 for a data bus 107 including data input/output (I/O) 107a-107d. During each main cycle the three control wires 106 are sampled on the rising and falling edge of the bus clock 109 for a total of 16 samples per main cycle.

The data I/O 107a-d may be configured as a single 32 bit port, for example, or as two x16 wide data paths to form two data ports, with a total of 32 I/O. Moreover, the data I/O circuits may be controlled as one or two groups. For example, a first independently controllable group may include a lower set of bits, such as 16 bits through data I/O 107a and 10b, and a second independently controllable group may include an upper set of bits, such as 16 bits through data I/O 107c and 107d.

The Memory IC includes a x8 version of memory 103, which may include data bus IO circuits. As shown, the Memory IC further include data strobes 108, including data strobes I/O pins 108a-108d. The data strobes 108 are used to indicate when the data appearing on the data bus is ready to be sampled. The Memory IC may further include a x16 version 104 that includes a single set of data strobes, a x16 version 100 with bytewide data strobes, and a x32 version 105 of memory with bytewide data strobes. In order to support multiple such Memory ICs co-resident on a common bus, a chip select 110 is incorporated to permit the device to be in the selected/active state or in a deselected/inactive state.

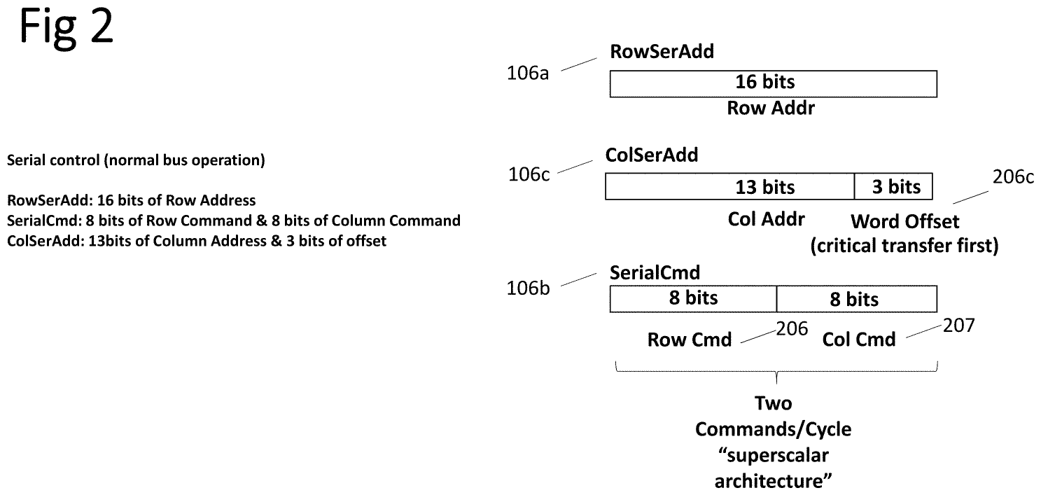

FIG. 2 shows a bit assignment for the bits sampled from the three control wires 106. The Row Serial Address 106a can be up to a 16 bit quantity. The Column Serial Address 106c consists of up to 13 bits of Column address plus three bits of Offset 206c.

A Word can be transferred within one main cycle which requires eight Bus Clock 109 Cycles to transport. For a 32 Byte word size and a 16 bit data bus a Quanta of 32 bits is transferred each Bus Clock Cycle and over an eight Bus Clock Cycle sequence eight sequentially addressed 32 bit Quanta are transported by the 16 bit data bus. Using a three bit Offset 206c it is possible to select which of the eight sequentially addressed Quanta will be the first to be transported. Subsequent 32 bit Quanta are transferred from sequential addresses in either an autoincrement or autodecrement mode within the Word with address wrap at Word ends.

In one implementation the Serial Command is divided into two eight bit fields, one for Row Commands 206 and the other for Column Commands 207. During a single Cycle a Row Command 206 and a Column Command 207 may be simultaneously executed leading to a superscalar type operating mode for the DRAM: two Commands are executed per cycle.

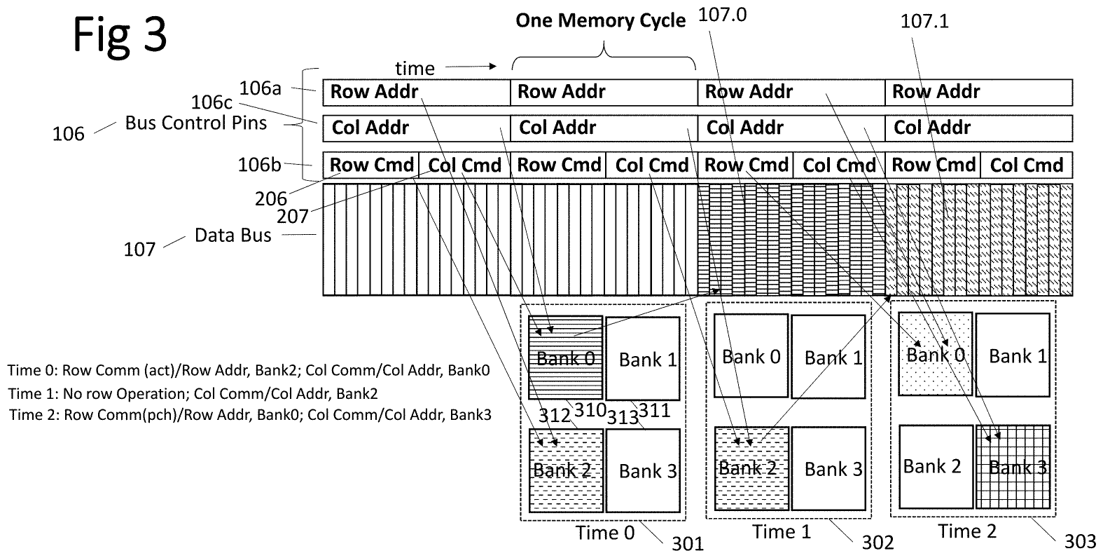

FIG. 3 shows a timing diagram illustrating how Row Commands 206, Row Addresses 106a, Column Commands 207 and Column Addresses 106c are received from the system bus and how operations directed to individual banks in the Memory IC are sequenced and controlled by these commands and addresses. In Timeslot 0 301, the Row Command 206 and Row Address 106a received in the previous memory cycle are executed. The Row Address 106a and Row Command 206 direct the memory to activate an address in Bank 2 312, At the same time in Timeslot 0 301, the Column Command 207 and Column Address 106c received in the said previous memory cycle are executed leading to reading from Bank 0. Due to core latency the requested data word 107.0 is driven on the Data Bus 107 during Timeslot 1 302. During Timeslot 0 301, a Column Command 207 is received from the SerCommand pin 106b directing a read from Bank 2 to be performed during Timeslot 1 302, with data therefrom 107.1 appearing on Data Bus 107 during Timeslot 2 303.

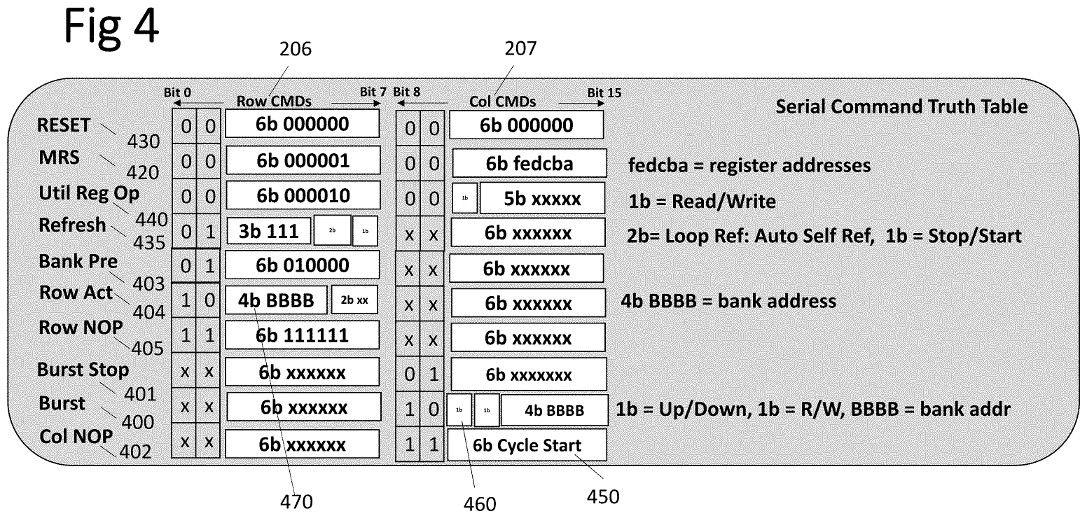

A truth table showing one possible set of bit assignments for the Row Commands and Column Commands is shown in FIG. 4. The first two bits for the Row Command and for the Column Command are used to define the operation. In cases where a Row Command may be issued concurrently with Column Command, for example, one set of operation bits are value XX indicating they may be any state (i.e. “don't care”). For example, a Bank Precharge 403 may occur at the same time as a Burst Read 400 or a Column NOP 402.

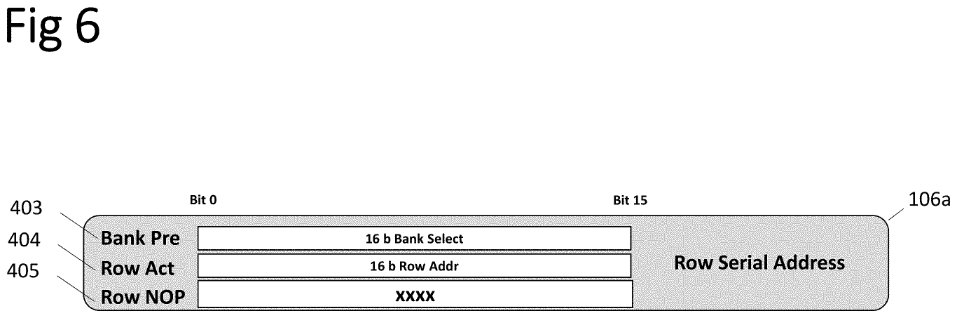

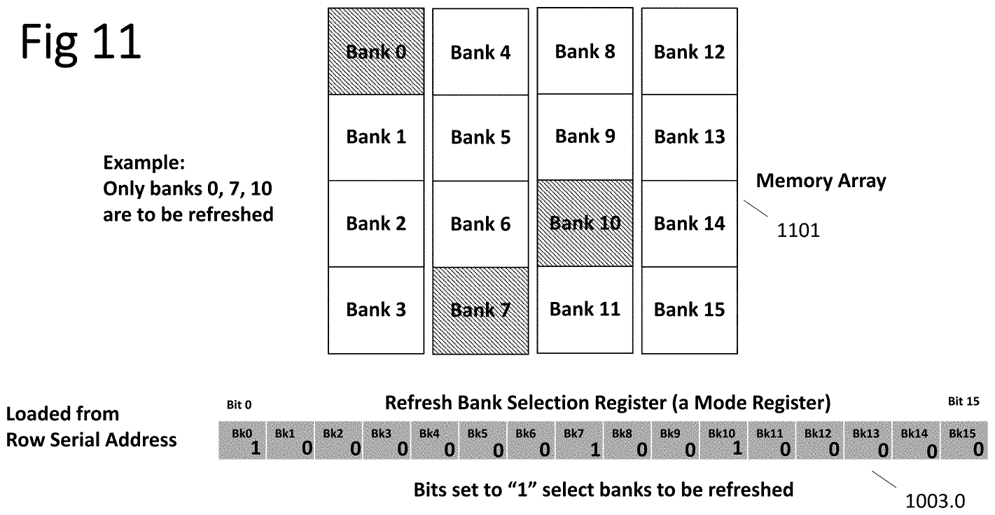

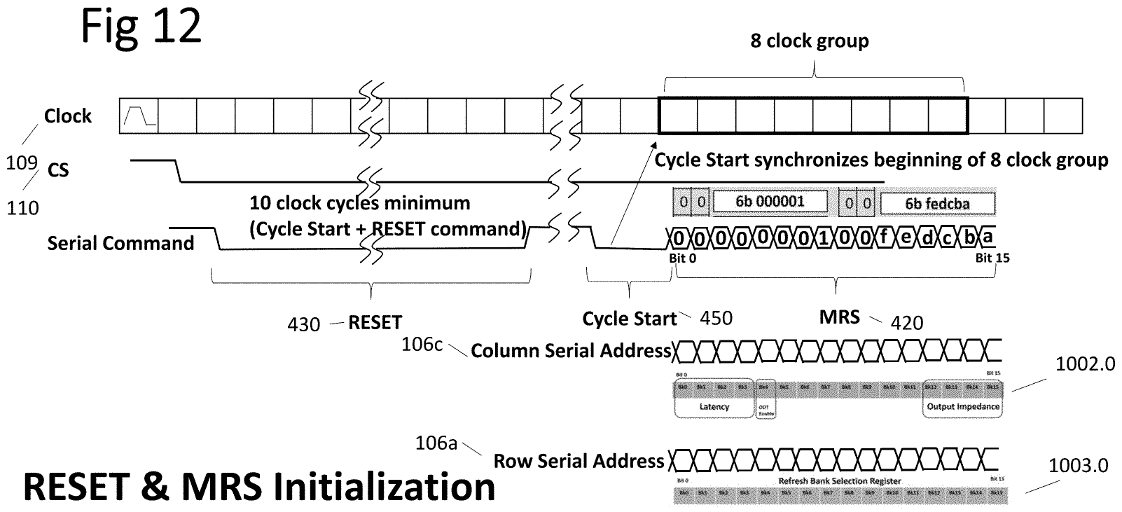

As shown in further detail in connection with FIG. 6, during Row Activation operations 404 the Row Serial Address 106a contains the address of the row to be activated. The Row Command 206 contains a field 470 specifying the Bank in which the requested Row is located. Refresh Cycles 435 are described in further detail below in connection with FIG. 11. Cycle Start command 450 is described in further detail below in connection with FIG. 12. The Row NOP command 405, is used when no Row operation is to be issued within a memory cycle. The Burst Stop 401 command is used to halt an ongoing Burst Read or Burst Write operation.

Some Commands are global such as RESET 430, Mode Register Set (“MRS”) 420, and some Utility Register Operations 440. In those cases, the Serial Command 106b is used to issue such commands to the Memory IC so specific Operation types are reserved for these cases.

Other bit mappings and functional combinations are possible and fit within the spirit of this invention.

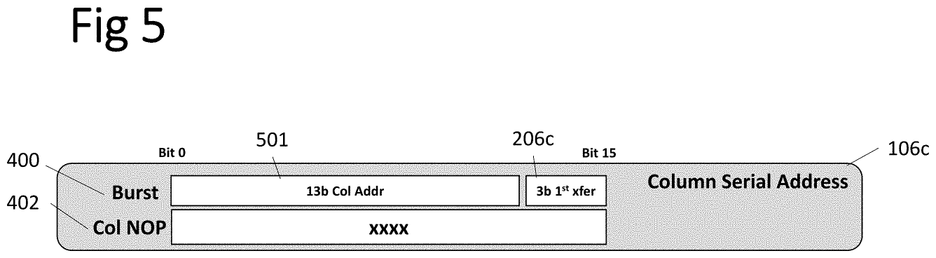

FIG. 5 shows the format of the Column Serial Address 106c. During Burst Cycles 400 it is interpreted as 13 bits of Column Address 501 and 3 bits of Offset 206c to select which of the eight Quanta is transported first. The Burst Command 400 shown in FIG. 4 includes an Up/Down bit 460 indicating whether addresses for subsequent in-Word Quanta transfers will autoincrement or autodecrement within the Word address boundary limits.

FIG. 6 shows the format of the Row Serial Address 106a. During Bank Precharge Commands 403 the Row Serial Address is used to control the banks to be precharged: any bit set to a “1” will enable the corresponding bank to be precharged. It is possible that a limit must be placed on the maximum number of banks that can be simultaneously precharged. This DRAM relies on the controller to conform to any such requirements and exposes total control of its internal resources to the controller for efficient management. During Row Activation operations 404 the Row Serial Address 106a contains the address of the row to be activated. The Row Command 206 contains a field 470 specifying the Bank in which the requested Row is located.

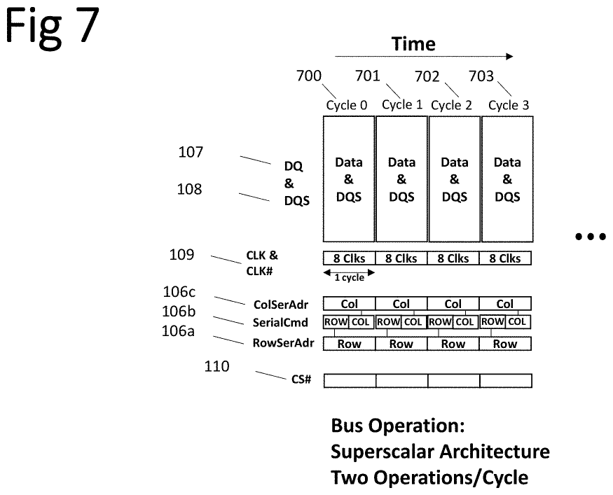

FIG. 7 shows a timing diagram of steady state burst operation with each Cycle receiving a new Row Command and a new Column Command Row and Column commands received during Cycle 0 700, operate during Cycle 1 701 on the Row Serial Address 106a and Column Serial Address 106c received during Cycle 0 700. Any data read while executing the commands during Cycle 1 701 appears on the Data Bus 107 during Cycle 2 702. In a similar manner, data appears in the Data Bus during Cycle 3 703 after being addressed in Cycle 1. Such a sequence can repeat for any number of memory cycles.

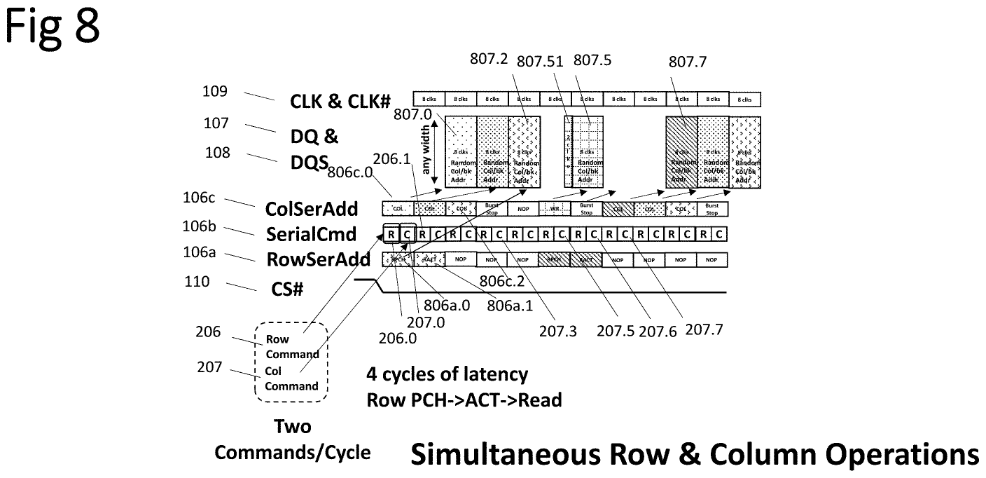

FIG. 8 shows a more detailed view of bus operation including an intermixing of Burst Read with Random Column Addressing overlapped with Bank Precharge and Row Activation operations and including a toggling from Burst Read to Burst Write and then returning to Burst Read. During one memory cycle, a Row Activation 404 command is issued as Row Command 206.0 during the same cycle, a Burst Read 400 is issued as Column Command 207.0. Column Address 806c.0 is received during this same memory cycle. Data packet 807.0 results from this read cycle. In the next memory cycle Row Activation 404 is received as Row Command 206.1 using Row Address 806a.1. In the next memory cycle, a Burst Read can be issued to this Row resulting in data 807.2.

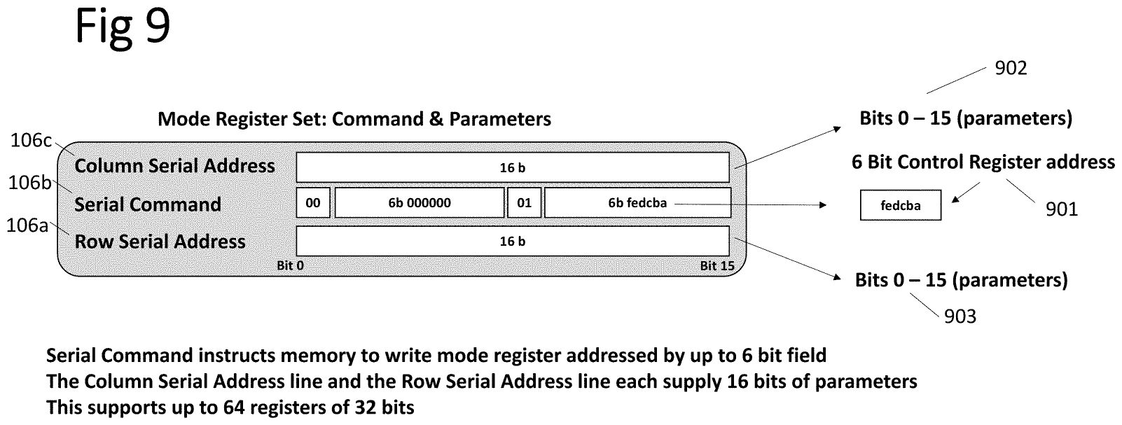

FIG. 9 shows how parameters for populating the Mode Registers are extracted from the Row Serial Address 106a and the Column Serial Address 106c during Mode Register Set Operations 402. The Serial Command 206 includes a six bit field 901 used to specify which Mode Register is selected for the Mode Register Set Operation. During a Mode Register Set operation, parameters are extracted from the Column Serial Address 106c and the Row Serial Address 106a to use for parameters 902 and 903 to form up to a 32 bit parameter field. Using six bits of addressing 901 up to 64 registers of 32 bits are supported.

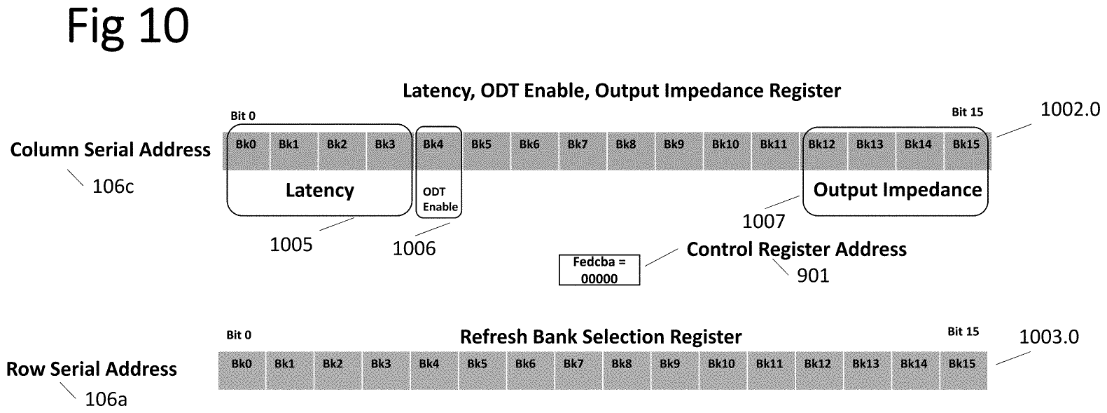

FIG. 10 shows two Mode Register field definitions. One, the Latency, ODT Enable, Output Impedance Register 1002.0, is used to set the Latency 1005, On Die Termination (“ODT”) control 1006 and the Output Impedance 1007 of the IO Drivers. This Mode Register receives its parameters from the Column Serial Address 106c line in this implementation of the invention but it could be received from the Row Serial Address Line 106a or the fields could be extracted from each of the two Serial Address lines, depending on specific implementation optimizations and still preserve the spirit of the invention. FIG. 10 also shows the Refresh Bank Selection Register 1003.0 which is loaded from the Row Serial Address 106a line. Once again other such mappings fit within the scope of the disclosure.

FIG. 11 provides a block diagram of a memory array 1101, illustrating how the Refresh Bank Selection Register is used during Refresh Cycles 435 (FIG. 4). This register controls which banks are refreshed. As an example, assume the DRAM is using Automatic Self Refresh (“ASR”). For power minimization it may be desirable to only refresh three banks as shown in FIG. 11. By setting the appropriate bits in the Refresh Bank Selection Register 1003.0, only Banks 0, 7 and 10 will be refreshed to save power.

FIG. 12 shows a method to RESET the Memory IC and then follow that by an MRS operation setting both the Latency/ODT/Impedance Mode Register and the Refresh Bank Selection Register. To reset the Memory IC, the device is Chip Selected with the Serial Command 106b held low for a minimum of 10 clock cycles to force RESET 430. The Memory IC can be initialized by issuing a Cycle Start 450 command followed by a MRS command 420. The Column Serial Address 106c and Row Serial Address 106a are sampled to load the various Mode Registers as explained above.

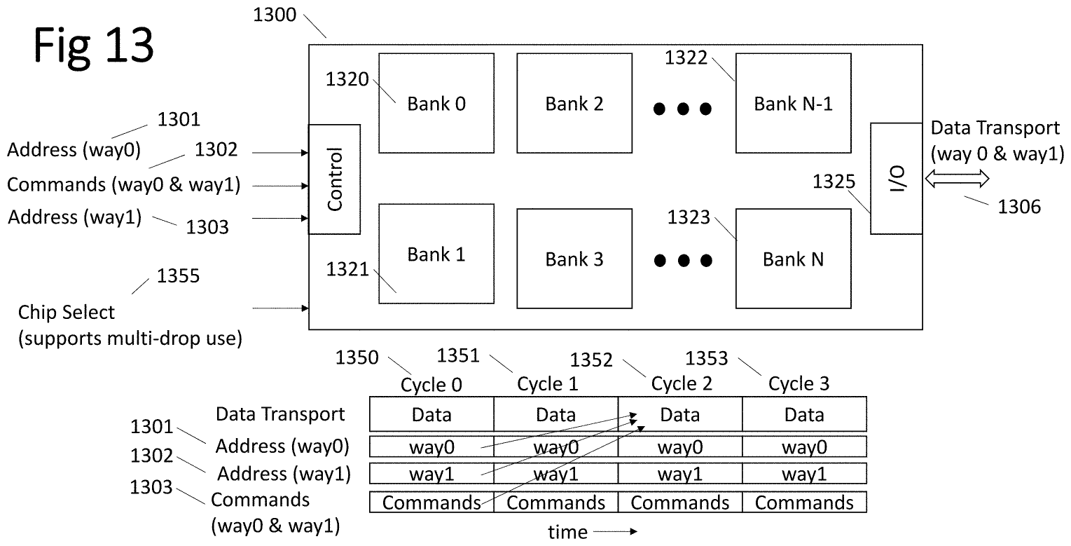

FIG. 13 shows a two-way superscalar version 1300 of the Memory IC, another implementation of the disclosure and a timing diagram showing pipelined read operation. A Two Way Superscalar Memory IC means a memory IC that has two independent ports (“Ways”) to access the same memory storage location contained within separately addressable memory banks 1320-1323, each “Way” including an independent addressing input port associated with that Way alone. This Memory IC can execute two commands per memory cycle (e.g., memory cycles 1350-1353) and each command can receive its full corresponding address also within the same single memory cycle. A shared port is used to receive commands 1302 which include a command for controlling Way 0 and a separate command for controlling Way 1. Addressing information for Way 0 1301 and Way 1 1303 is received via separate ports. In one implementation of the disclosure the two address ports are implemented using two conductor pins, such as IC signal pins, and the single command port is implemented using a single conductor pin, such as an IC signal pin.

In this two-way superscalar memory IC, it is possible to read from two banks 1320-1323 at the same time or to write to two banks 1320-1323 at the same time. For example, a request received through a first address port may initiate a read from bank 1321, while a separate request received through a second address port may initiate a read from bank 1322. If the Memory IC is implemented using DRAM technology either Way can issue a Bank Precharge or a Row Activation command to the same memory array.

For a dual read operation requested in Cycle 0 1350 data appears in cycle 2 1352 from the Way 0 address 1301 location and the Way 1 address 1302 location during Cycle 0 1350. Data is transported on off the Memory IC via I/O port 1325 via bus 1306.

Because the two-way superscalar memory is beneficially used in a multi-drop configuration in some system applications, a Chip Select pin 1355 is included to permit one chip of a group to be selected as the active chip on the bus.

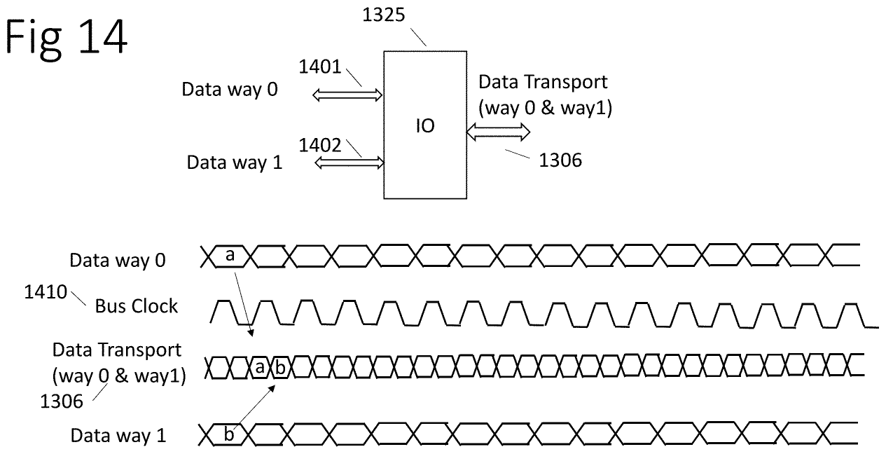

FIG. 14 shows a timing diagram illustrating the operation of one implementation of the IO circuit 1325. In this example Bus Clock 1410 is used to cycle the Data Transport port 1306 using DDR type signaling. Internal buses Data Way 0 1401 and Data Way 1 1402 are SDR Rate signaling. The IO circuit combines the two internal buses such that Way 0 data is transported during the High Phase of Bus Clock 1410 and Way 1 data is transported during the Low Phase of Bus Clock 1410. For 128 bit wide buses comprising Way 0 and Way 1, a DDR-rate external IO Data Transport bus will necessarily be a 128 bit wide DDR type bus.

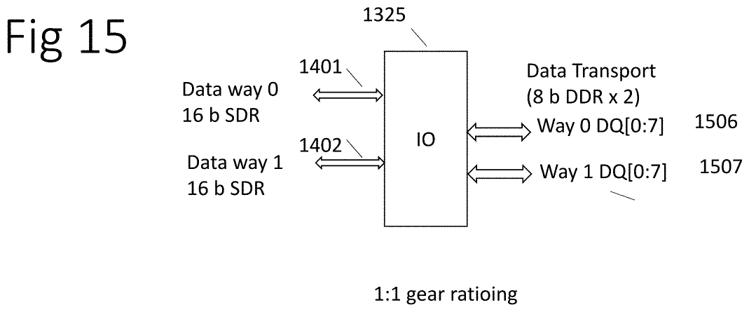

FIG. 15 shows an alternate configuration for the Data Transport bus such that it is split into a separate Data bus for Way 0 1506 and separate Data bus for Way 1 1507. The buses can be operated independently such that one may be in Read mode while the other is in Write mode or any other such combination. Using the same SDR/DDR relationship as the common bus of FIG. 14, this can be a configuration option for the Memory IC.

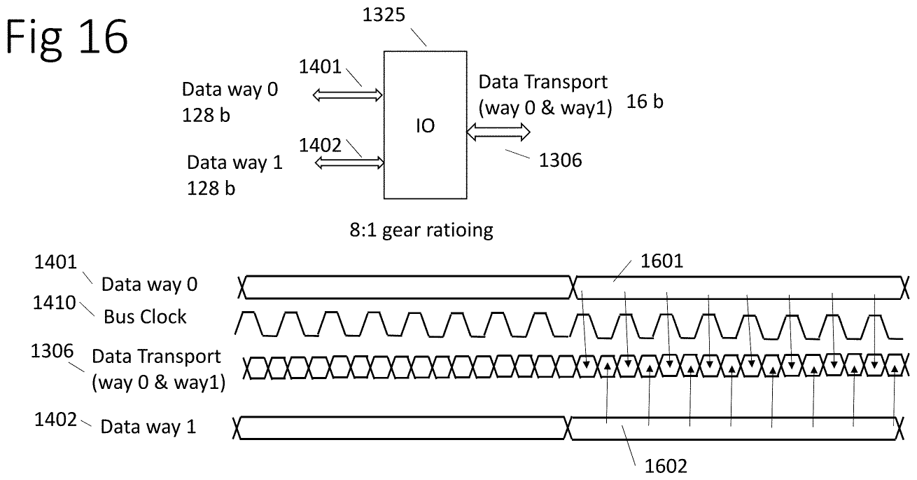

FIG. 16 shows a timing diagram illustrating the operation of one implementation of the IO circuit 1325. In this example Bus Clock 1410 is used to cycle the Data Transport port 1306 using DDR type signaling. Internal buses Data Way 0 1401 and Data Way 1 1402 are SDR Rate signaling. The IO circuit combines the two internal buses such that Way 0 data 1601 is transported during the High Phase of Bus Clock 1410 and Way 1 data 1602 is transported during the Low Phase of Bus Clock 1410. For 128 bit wide buses comprising Way 0 and Way 1, a DDR-rate external IO Data Transport bus limited to 16 bits width will necessarily operate at 8×the frequency of the internal Way buses using a so called 8:1 gear ratioing.

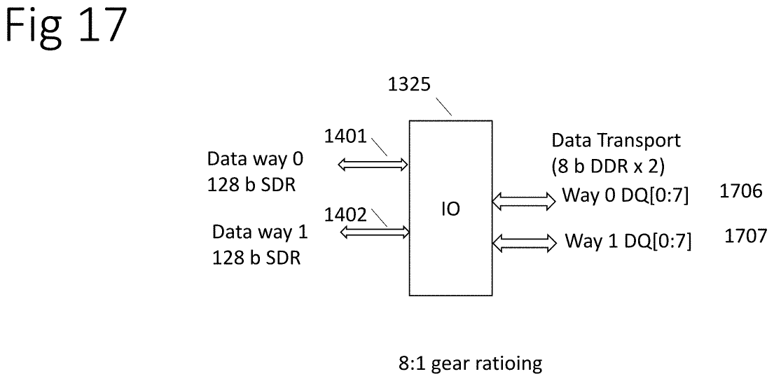

FIG. 17 shows an alternate configuration for the Data Transport bus such that it is split into a separate Data bus for Way 0 1706 and separate bus for Way 1 1707. The buses can be operated independently such that one may be in Read mode while the other is in Write mode or any other such combination. Using the same SDR/DDR relationship as the common bus of FIG. 14, this can be a configuration option for the Memory IC.

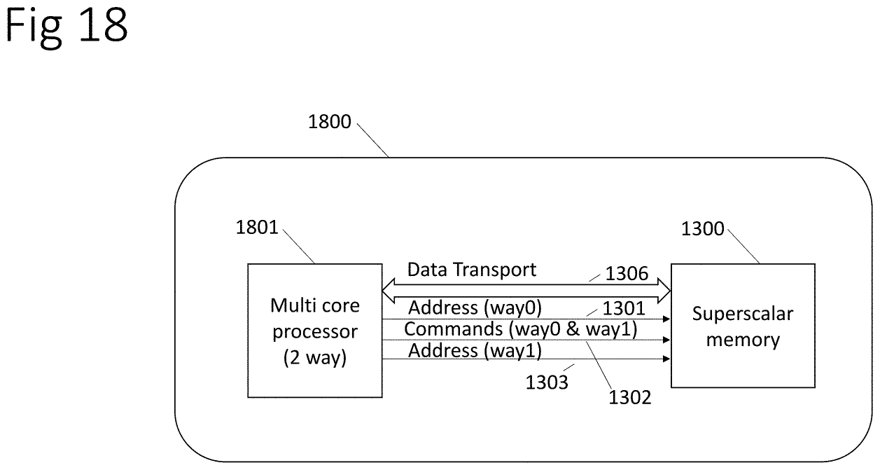

FIG. 18 shows a Multi-Core Processor 1801—Superscalar memory 1300 subsystem 1800. A data bus 1306 is used to transport data between the processor and memory. The processor provides a command stream via a command port 1302 connected to the memory. The processor also provides separate Way 0 and Way 1 address streams via two separate address ports 1301 and 1303 assigned to Way 0 and Way 1 respectively. The multicore processor may be implemented as a multi-way superscalar processor that dispatches two or more instructions per cycle or two independent processor cores, each executing a different instruction stream. The data bus may be configured as a single bus or as a bus dedicated to each Way; such that one bus may be in Read mode while the other is in Write Mode or any other such combination.

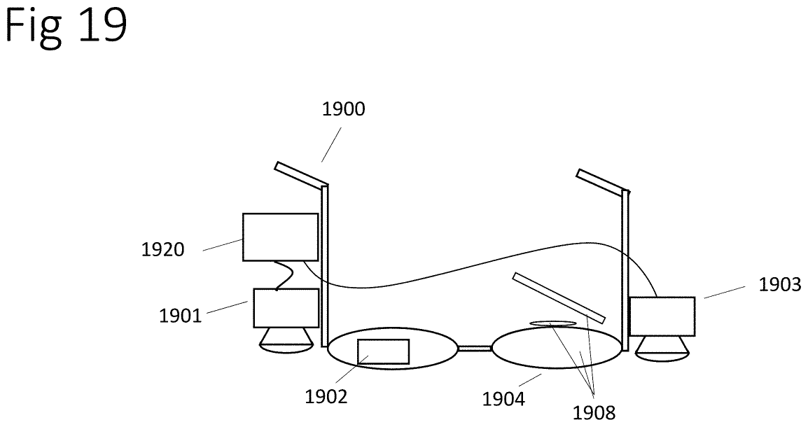

FIG. 19 shows an appliance 1900 designed to capture, process and display natural data types in realtime. The appliance 1900 consists of a sensor subsystem 1901 and optional additional sensor subsystem(s) 1903, both coupled to a support system 1904 that may include a display element 1902 and or optical elements 1908. A processor-memory subsystem 1800 is contained within electronics unit 1920. Because of the requirement to operate in realtime, preventing long processor stalls reduces the risk of overflowing data buffers of limited capacity. By dedicating a processor core to servicing the capture and storage requirements of real time capture from sensors of natural data types such as a video camera, risks of long processor stalls can be reduced. For battery powered and miniaturized human-wearable appliances incorporating such features as high resolution video capture, processing, storage and display it is desirable to implement the processor-memory subsystem in no more than two ICs, yet to maintain acceptable frame rate and resolution. The superscalar memory offers additional levels of parallelism over conventional single task memory components in these footprint constrained systems.

As the foregoing has illustrated, one embodiment of this invention is a multi-bank DRAM that can, in a given memory cycle, perform a row operation in one memory bank concurrent with a column operation in a different memory bank of the same DRAM, using row address information and column address information simultaneously received from separate pins in a preceding memory cycle.

Another embodiment of this invention is a multi-bank DRAM that can receive two independent addresses concurrently from external pins and use these to concurrently address two different on-chip memory banks.

Still another embodiment of this invention is a multi-bank Superscalar DRAM that uses one pin to receive commands, one pin to receive addresses for one Way, another pin to receive addresses for a different Way and two independently controllable Data IO ports to permit any memory storage location within the memory IC to be accessed via either Way.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A Memory IC, comprising:
a single external Data IO Port configured to receive data to be stored in the Memory IC and to transmit data read from storage in the Memory IC;
a single external command input port configured to receive commands;
a first external address input port configured to receive a first address; and
a second external address input port configured to receive a second address;
the commands operable on the first address and the second address to simultaneously access two different regions in the Memory IC.

2. The Memory IC of claim 1 where the commands include a first operation type command and a second operation type command, wherein the Memory IC can receive both a first operation type command and second operation type command from the external command input port during a single memory cycle and the Memory IC can execute both a first operation type command and a second operation type command at the same time using addressing information obtained by simultaneously sampling the first and second external address input ports.

3. The Memory IC of claim 2, where the memory IC is a dynamic random access memory (“DRAM”).

4. The Memory IC of claim 3, where the first address is a row address.

5. The Memory IC of claim 4, where the second address is a column address.

6. The Memory IC of claim 5, wherein the external command input port comprises a single conductor pin.

7. The Memory IC of claim 6 wherein the external first address input port comprises a single conductor pin.

8. The Memory IC of claim 7 wherein the external second address input port comprises a single conductor pin.

9. The Memory IC of claim 8 where the first operation type command is a row command.

10. The Memory IC of claim 9 where the second operation type command is a column command.

11. The Memory IC of claim 1 where the Data IO port is configured as two separately controllable groups of IO circuits, each such circuit within a group coupled to an external terminal designed to be coupled to one conductor of a multi-conductor data bus; an IO operation of each said group of IO circuits independently controllable such that when the memory IC is in operation, one group of Data IO port circuits can transmit data addressed by the first external address input port across a first multi-conductor data bus while the other group of Data IO port circuits can receive data addressed by the second external address port via a second multi-conductor data bus.

12. A processor-memory subsystem comprising a multi-core processor and a Memory IC wherein the Memory IC includes:
a single external Data IO Port configured to receive data to be stored in the Memory IC and to transmit data read from storage in the Memory IC;
a single external command input port configured to receive commands;
a first external address input port configured to receive a first address; and
a second external address input port configured to receive a second address;
the commands operable on the first address and the second address to simultaneously access two different regions in the Memory IC.

13. The processor-memory subsystem of claim 12 where the commands include a first operation type command and a second operation type command, wherein the Memory IC can receive both a first operation type command and second operation type command from the external command input port during a single memory cycle and the Memory IC can execute both a first operation type command and a second operation type command at the same time using addressing information obtained by simultaneously sampling the first and second external address input ports.

14. The processor-memory subsystem of claim 13 where the Data IO port is configured as two separately controllable groups of IO circuits, each such circuit within a group coupled to an external terminal designed to be coupled to one conductor of a multi-conductor data bus; an IO operation of each said group of IO circuits independently controllable such that when the memory subsystem is in operation, one group of Data IO port circuits can transmit data addressed by the first external address input port across a first multi-conductor data bus while the other group of Data IO port circuits can receive data addressed by the second external address port via a second multi-conductor data bus.

15. An appliance comprising a multi-core processor and a Memory IC wherein the Memory IC includes:
a single external Data IO Port configured to receive data to be stored in the Memory IC and to transmit data read from storage in the Memory IC;
a single external command input port configured to receive commands;
a first external address input port configured to receive a first address; and
a second external address input port configured to receive a second address;
the commands operable on the first address and the second address to simultaneously access two different regions in the Memory IC.

16. The appliance of claim 15 where the commands include a first operation type command and a second operation type command, wherein the Memory IC can receive both a first operation type command and second operation type command from the external command input port during a single memory cycle and the Memory IC can execute both a first operation type command and a second operation type command at the same time using addressing information obtained by simultaneously sampling the first and second external address input ports.

17. The appliance of claim 16 where the Data IO port is configured as two separately controllable groups of IO circuits, each such circuit within a group coupled to an external terminal designed to be coupled to one conductor of a multi-conductor data bus; an IO operation of each said group of IO circuits independently controllable such that when the appliance is in operation, one group of Data IO port circuits can transmit data addressed by the first external address input port across a first multi-conductor data bus while the other group of Data IO port circuits can receive data addressed by the second external address port via a second multi-conductor data bus.
